(19) United States
(12) Patent Application Publication
(10) Pub. No.: US 2010/0183250 A1
(43) Pub. Date: Jul. 22, 2010

(54) Bag with Lateral Folds

(75) Inventors: Johannes Wedi, Emsdetten (DE); Rudolf Haimerl, Konzell (DE); Peter Strübbe, Lengerich (DE)

Correspondence Address: GUDRUN E. HUCKETT DRAUDT, SCHUBERTSTR. 15A, WUPPERTAL, 42289, DE

(73) Assignee: Bischof + Klein GmbH & Co. KG, Lengerich (DE)

(21) Appl. No.: 12/664,403

(22) PCT Filed: May 30, 2008
(86) PCT No.: PCT/EP2008/004299

§ 371 Date: Dec. 21, 2009

(30) Foreign Application Priority Data
Jun. 14, 2007 (DE) 10 2007 027 994.0

(51) Int. Cl. B65D 30/20; B31B 1/00

(52) U.S. Cl. 383/120; 493/267

(57) ABSTRACT

The invention relates to a bag with lateral folds (1) with a weldable or sealable sheet lying upon at least one layer internal to the bag with two opposite main walls (2, 3) and two lateral fold walls (4, 5) lying therebetween, which join with extensions in a floor (9) and are connected there through at least one floor seam (10) in such a manner that the lateral fold walls (4, 5) are connected to each other on both sides of a fold corner (13, 14) flush with the adjacent main wall (2, 3) and such that, in addition, the main walls (2, 3) are connected to each other and are connected by a one-piece sheet running between main wall and floor designed for the improvement of the floor contour and the stability such that the floor (9) is delimited from each of the two main walls (2, 3) by a fold seam (11, 12).

The invention concerns a bag with lateral folds according to the preamble of claim 1 and a method for its manufacture.

Bags with lateral folds with bottom closure by means of a bottom seam are widely used. In an especially simple case the main walls and the folded-in lateral fold walls are closed off at the bottom side by transversely extending bottom seams aligned with one another. The main walls that for this purpose are placed flat on top one another and the side walls folded therebetween are contiguous in a hose shape or tubular shape, be it that they are joined from a width of a film with only one seam, for example, at a main wall that is predetermined as a rear wall, or that they are combined of film strips that are connected to one another by longitudinal seams between the main walls and the lateral fold walls. In this connection, along the line of the bottom seams on both sides not only the two fold sides of the lateral fold walls can be connected with the neighboring main walls to a bottom closure of the bag; also, the two sides of each lateral fold wall can also be connected with one another at least in a spot pattern in order to prevent projecting ears and to place the ears against the bottom. In the bottom area there can also be so-called “diagonal seams” that, for example, extend from the end of the fold of each lateral fold wall at a slant outwardly to the corners of the bottom area and thus provide a contour for the shape of the bottom or even form themselves the tight closure of the bag in this area.

The known lateral fold bags have however no dear delineation between the bottom and the main walls (and lateral fold walls) as a result of the simple configuration of the bottom as a continuation of the main and lateral fold walls. The regularly desired parallelepipedal configuration of the lateral fold bags results only once it is filled and, in case of bulk material or liquids that are usually packaged in such bags, this can result in undefined displacements and deformations. This then however constitutes insecurities with respect to stand-up behavior, the upright stability of such bags is often unacceptable. In case of bags that are stacked flat in a storage facility or in particular also on sales shelves, it is important that the bottom can be provided with a suitable print pattern that is areal and as a whole is easily visible. In this respect conventional lateral fold bags also have flaws.

As a remedy, lateral fold bags are found in practice that are closed off by a separate bottom cover sheet that is circumferentially sealed to the main and lateral fold walls. This configuration provides a better upright stability and also a well-defined bottom as a printing surface and visible surface but with respect to manufacture it is very complex and is also critical as a result of the complex manufacturing method and the greater length of the sealing seams with regard to seal-tightness of the bottom closure.

The object of the invention is therefore to provide a lateral fold bag that can be produced simply and inexpensively, that however has improved upright stability and also a defined bottom as a printing surface.

According to the invention this object is solved based on a lateral fold bag according to the preamble of claim 1 based on the characterizing features of claim 1. Furthermore, this object is solved by a method according to claim 6.

In a surprisingly simply executable modification of the lateral fold bag of the aforementioned kind an improvement of the upright stability and a flat delimited configuration of the bottom have been achieved even for flat stacking in that the bottom is delimited by fold seams. The incorporation of such a fold seam must not cancel the continuous extension of the film of the main walls to the bottom; instead, it is sufficient to provide a fold that is fixed by sealing, welding or, if necessary, gluing and that does not cause seal-tightness problems. On the other hand, such a fold seam is suitable to force an edged positioning of the neighboring film areas relative to one another and to shape the bottom in this way.

The fold seams can extend expediently across the entire width of the main walls even if a support and contouring function of these fold seams were already be provided by means of partial sections. The fold seams, when the lateral fold walls are also connected with the main walls by sealing seams, respectively, can abut these sealing seams and form a frame for the bottom.

A method for producing such lateral fold bags is typically based on manufacturing a circumferentially closed hose that forms the main walls, the lateral fold walls and, moreover, also contains a portion of the bottom, respectively. Such a hose is initially frequently produced “endless” and then is cut to length in a predetermined way. When in a continuous method the individualized pieces are then turned so as to extend transversely to the conveying direction, bottom seams can be applied so as to extend advantageously in the conveying direction. Also, the top side configurations of the bag, for example, with incorporation of reclosable closures, can be realized in parallel in continuous process steps.

In this connection, without a problem also processing of the bottom side with incorporation of the fold seams according to the present invention can be realized which fold seams preferably extend parallel to the bottom seam connecting the main walls. The fold seams can be introduced in such a way that the bottom area with the aid of an appropriate tool can be alternatingly placed flat onto one and then the other of the two main walls in order to positionally fix the fold line in the form of a seam, respectively. However, the fold seams can also be formed by an inner tool that is inserted into the bag and forms the contour of the bottom.

Expediently, the bottom seam is attached or adhesively connected by sealing, welding or gluing flat against the bottom so that it does not project like a fin downwardly. The attachment can be limited optionally to partial sections that are sufficient for an appropriate fixation.

One embodiment of the invention is illustrated in the drawing and will be explained in the following in more detail. In the drawing it is shown in:

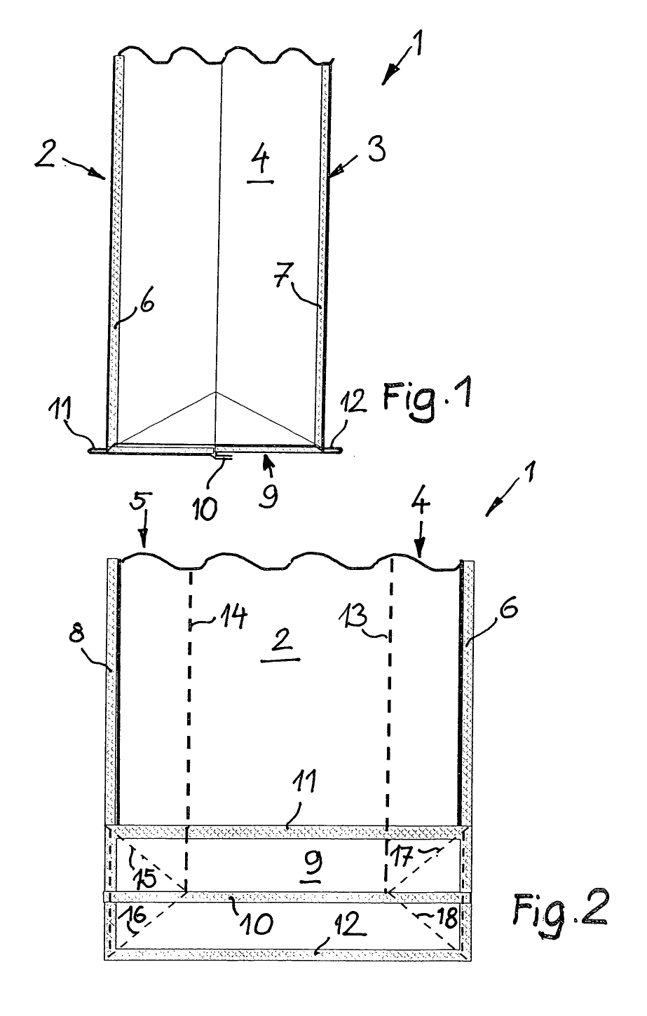

FIG. 1 a side view of a lateral fold bag according to the invention; and

FIG. 2 a front view of the lateral fold bag according to FIG. 1 with the bottom folded against the front.

The lateral fold bag illustrated in the drawing and identified as a whole at 1 comprises two main walls 2, 3, a visible lateral fold wall 4 and a lateral fold wall 5 that is hidden in FIG. 1, wherein all walls are connected to one another by longitudinal seams that also simultaneously provide contouring and stiffening of the parallelepipedal filling position illustrated in FIG. 1. In FIG. 1, the longitudinal seams 6, 7 between the lateral fold wall 4 and the neighboring main walls 2, 3 are shown and, moreover, in FIG. 2 a longitudinal seam 8 between the main wall 2 and the neighboring lateral fold wall 5 is shown. A bottom 9 is formed by projecting extensions of the main walls 2, 3 and the lateral fold walls 4, 5 and in the present case is closed off by a single continuous bottom seam 10 by which, in the central area, the extensions of the main walls 2, 3 are sealed together while at both sides in the folding area of the lateral fold walls 4, 5 the folded-in lateral fold walls that are resting flat against the main walls are sealed in their contact area to the main walls so that in this way a continuous seal-tight bottom closure of the lateral fold bag 1 is produced. The bottom seam 10 can however also combine the halves of the lateral fold walls 4, 5 with one another by welding or sealing in order to hold them together and to avoid that they form projecting ears. This is also possible as a result of special measures when the film from which the lateral fold bag is produced is only sealable at the inner side. The frequent use of polyolefins for an inner layer, for example, polyethylene, combined with an outer layer of polyester conflicts with a direct sealing action of the bottom edges of the lateral folds because here the polyester sides rest against one another. When however partial areas within the seam are cut out of the lateral fold walls, the inner sides of the main walls 2, 3 will contact one another directly at this location and can be sealed. This incorporates the bottom edges of lateral folds and provides a continuous bottom seam 10.

The bottom seam 10, for a commonly used configuration in the form of a “fin seam”, could project downwardly which possibly would be undesirable for the desired configuration of the lateral fold bag with a bottom surface. In the especially frequently employed embodiment of such a bag with films that are sealable with one another only at the inwardly positioned layer, the flat positioning of the bottom seam 10 illustrated in FIG. 1 cannot be achieved simply by sealing. In this context, adhesive connections are preferred that position the bottom seam 10 flat against the bottom 9; however, they must not be applied continuously but can affix only spot by spot or section-wise.

The afore described bag is provided with a decisively improved upright stability and a defined flat bottom configuration by means of the fold seams 11, 12 that can be incorporated by sealing based on the sealable inner layers of the film of the main walls 2, 3 without the film having to be pieced on or cut at this location. In that the transition of the film of the main walls 2, 3 into the bottom 9 is realized with a continuing film that is only folded strip-wise on top and sealed together at the fold seams 11, 12, the sealing action of the bag in this area remains untouched. The fold seams 11, 12 form a frame-shaped or strip-shaped contour of the bottom in delineation to the main walls 2, 3. This improves the upright stability of the lateral fold bag when placed on the bottom significantly and provides a well-defined printing surface for information and identification with regard to the bag when the bag is stacked in a flat horizontal position so that only its bottom is visible.

While conventional empty lateral fold bags with a bottom seam are usually folded with continuously inwardly folded lateral fold walls and with a that is folded downwardly flat to the bottom seam, the bottom 9 is preferably in accordance with FIG. 2 folded like a plate as a whole against one of the main walls, here the main wall 2. This results in a multi-layer configuration in the bottom area which however in most cases is quite advantageous inasmuch as the top area of such bags provided with recloseable closures and the like also is provided with a thicker construction. In this respect, shipment of such bags in the flat stacked arrangement is more uniform. The flat configuration according to FIG. 2 with folded-in bottom 9 causes also below the bottom a clean fold arrangement. For example, the lateral fold walls 4 or 5, beginning at their fold lines 13, 14 in the area of the main walls 2, can be folded flat in the bottom area along diagonal folds 15, 16, 17, 18 wherein these diagonal folds can also be found in conventional bags as sealing seams between the lateral fold walls and the main walls and insofar can be employed also herein in an expedient way.

In a relatively simple way, the lateral fold bag according to the invention can be produced with conventional technology and on conventional manufacturing devices in a configuration with fold seams but leads to surprising advantages with respect to the stand-up behavior as well as with respect to the presentation of the bottom as a printing surface for stacking in a horizontal position.

What is claimed is:

1.-10. (canceled)

11. A lateral fold bag comprising;
two main walls positioned opposite one another and two intermediately positioned lateral fold walls, each comprised of at least one layer of sealable film, wherein at least one layer of sealable film is positioned at an inner side of the lateral fold bag;
wherein the two main walls and the two lateral fold walls each have an extension extending into a bottom of the lateral fold bag;
wherein the extensions are connected to one another by at least one bottom seam at the bottom in such a way that the two lateral fold walls on either side of a fold edge of the lateral fold walls are connected flat to the neighboring main walls and the main walls are connected to one another;
wherein a contour of the bottom is delimited relative to the two main walls by a fold seam, respectively.

12. The lateral fold bag according to claim 11, wherein the two fold seams extend across an entire width of the main walls.

13. The lateral fold bags according to claim 11, wherein the main walls and the lateral fold walls are delimited relative to one another by sealing seams.

14. The lateral fold bag according to claim 11, wherein the extensions of the main walls and the extensions of the lateral fold walls are connected to one another by diagonal seams.

15. The lateral fold bag according to claim 11, wherein the bottom seam is attached flat to the bottom at least section-wise.

16. A method for producing a lateral fold bag according to claim 11, the lateral fold bag comprising a hose that is circumferentially closed and comprised of main walls and lateral fold walls each having a continuing section, wherein the continuing sections are closed at the bottom of the lateral fold bag by at least one bottom seam, the method comprising the step of producing a fold seam between the main walls and the bottom, respectively.

17. The method according to claim 16, wherein, in the step of producing, the fold seams are applied in that the bottom is alternatingly resting against one of the main walls.

18. The method according to claim 16, comprising the step of inserting into the hose an internal tool that forms the bottom of the lateral fold bag, wherein the fold seams are produced after the step of inserting.

19. The method according to claim 16, wherein the at least one bottom seam is glued flat to one side against the bottom.

20. The method according to claim 16, wherein the lateral fold bag is stacked with the bottom being folded flat to one side.
